(19) United States
(12) Patent Application Publication
(10) Pub. No.: US 2008/0268667 A1
(43) Pub. Date: Oct. 30, 2008

(54) Elastic terminal structure

(75) Inventors: Kuang-Hua Shiu, Hukou Township (TW); Rui-Hong Huang, Hukou Township (TW); Qui-Da Xie, Hukou Township (TW); Qian-Hao Luo, Hukou Township (TW)

Correspondence Address: Troxell Law Office Pllc, Suite 1404, 5205 Leesburg Pike, Falls Church, VA, 22041, US

(73) Assignee: Singatron Enterprise Co., Ltd.

(21) Appl. No.: 11/790,297

(22) Filed: Apr. 24, 2007

(51) Int. Cl. H01R 12/00

(52) U.S. Cl. 439/66

(57) ABSTRACT

The present invention provides an improved elastic terminal structure, wherein an elastic terminal includes an extended portion, a soldering portion and an elastic portion. Embedding members corresponding to a base extend from the extended portion of the elastic terminal to enable firmly clasping the elastic terminal within the base. Moreover, the elastic portion formed by press machining extends from the extended portion, and a helical member extends from the elastic portion. Furthermore, an electrical conducting point that enables conducting of electric power extends from the helical member. Elastic compression of the helical member and extension of the electrical conducting point are used to enable a conducting member to compress the electrical conducting point, moreover, the cost of the manufacturing process is reduced and the problem of elastic fatigue is minimized.

### BACKGROUND OF THE INVENTION

(a) Field of the Invention

The art of the present invention provides an improved elastic terminal structure, and more particularly to an elastic terminal structure that enables use of elastic compression and an electrical conducting point of a helical member when a conducting member is electrically connected thereto.

(b) Description of the Prior Art

Referring to FIG. 1, which shows a conventional conducting terminal A used to conduct electric power, the objective of which is achieved by joining the conducting terminal A to a power supply element, wherein during the manufacturing process, additional molding of a main body Al of the conducting terminal A must be first implemented separately. Hence, the need for a separate molding operation consumes the cost of the manufacturing process, and the processing steps are finicky and troublesome. Furthermore, elastic fatigue easily occurs in the main body Al after long usage, which results in electrical conducting points of the conducting terminals A being uneven, causing concern over poor electrical conduction with a power supply element.

Hence, the inventor of the present invention proposes to resolve and surmount existent technical difficulties to eliminate the aforementioned shortcomings of prior art.

### SUMMARY OF THE INVENTION

The art of the present invention provides an improved elastic terminal structure, and more particularly to an elastic terminal structure that enables use of elastic compression and an electrical conducting point of a helical member when a conducting member is electrically connected thereto and reduces the cost of the manufacturing process and minimizes the problem of elastic fatigue.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of prior art.

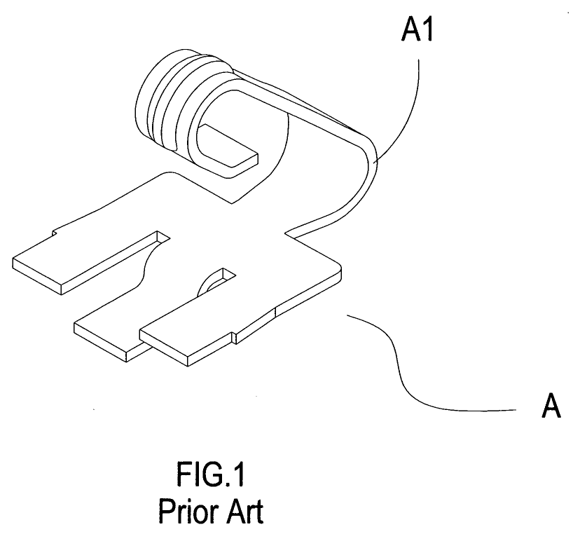

FIG. 2 shows an elevational view according to the present invention.

FIG. 3 shows a first elevational view of an embodiment according to the present.

FIG. 4 shows a second elevational view of an embodiment according to the present.

FIG. 5 shows a third elevational view of an embodiment according to the present.

FIG. 6 shows a fourth elevational view of another embodiment according to the present.

### DETAILED DESCRIPTION OF THE PREFERRED EMBODIMENTS

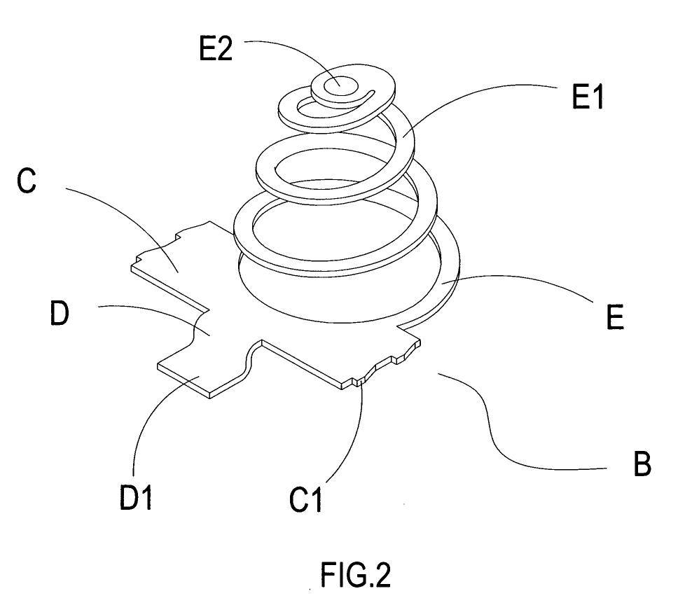

Referring to FIG. 2, which shows an improved elastic terminal structure of the present invention, wherein an elastic terminal B is structured to comprise an extended portion C, a soldering portion D and an elastic portion E. Mutually corresponding embedding members C1 extend from the plane surface of the extended portion C, and a soldering portion D extends from one side of the extended portion C. A soldering piece D1 that enables electrical conduction extends from the soldering portion D, and the elastic portion E formed by press machining extends from another side of the extended portion C. Moreover, a helical member E1 is press extended from the elastic portion E, and an electrical conducting point E2 that enables conducting of electric power extends from the helical member E1. Elastic compression of the helical member E1 and the press formed elastic portion E are used to enable a conducting member to compress the electrical conducting point E2, moreover, the cost of the manufacturing process is reduced and the problem of elastic fatigue is minimized.

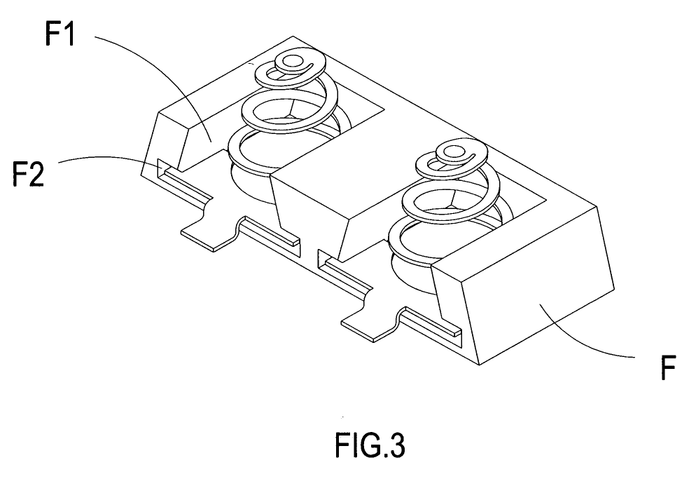

Referring to FIG. 2 and FIG. 3, which show an embodiment of the improved elastic terminal structure of the present invention, wherein the elastic terminals B are installed in a base F that is provided with functionality to enable electrical conductivity and embedding of elastic terminals. The base F is configured with one or more than one holding space F1, and corresponding clasp slots F2 are respectively defined in the holding spaces F1, thereby enabling the elastic terminals B to be respectively embedded tin the base F. When installing the elastic terminals B in the holding spaces F1, the clasp slots F2 respectively firmly clasp the mutually corresponding embedding members C1 extending from the extended portion C of each of the elastic terminals B, thereby enabling the elastic terminals B to be fixedly disposed in the holding spaces F1 of the base F and achieve stable and firm embedding effectiveness. The elastic portion E formed by press machining extends from the other side of the extended portion C, the helical member E1 is press extended from the elastic portion E, and the electrical conducting point E2 that enables conducting of electric power extends from the helical member E1. Accordingly, elastic compression of the helical member E1 and the press formed elastic portion E are used to enable the elastic terminal B to achieve conducting effectiveness, moreover, the cost of the manufacturing process is reduced and the problem of elastic fatigue is minimized.

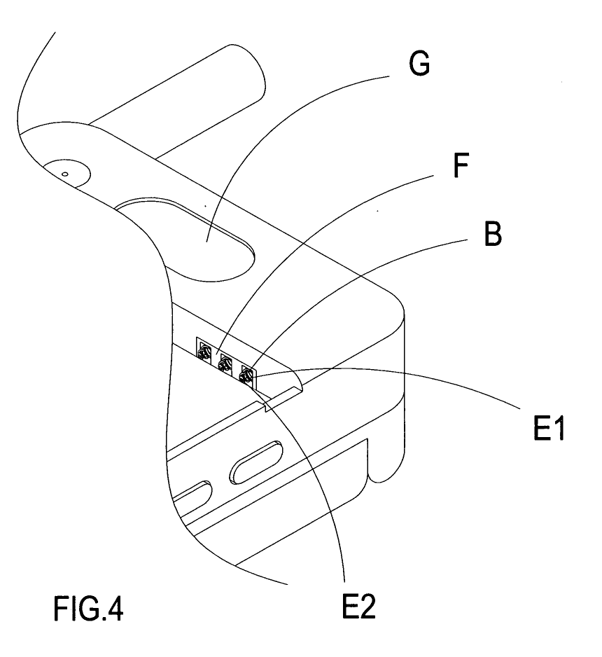

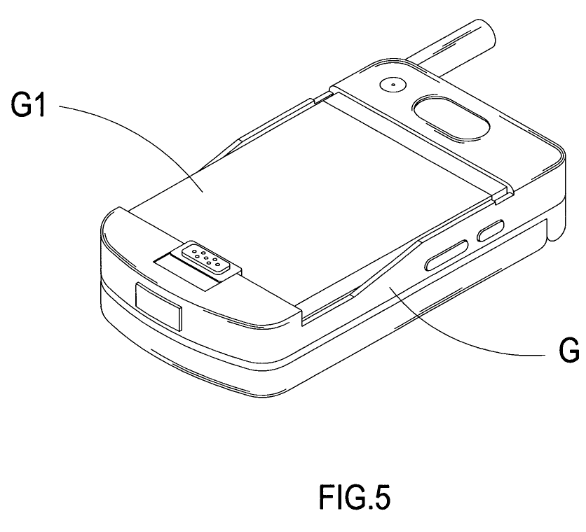

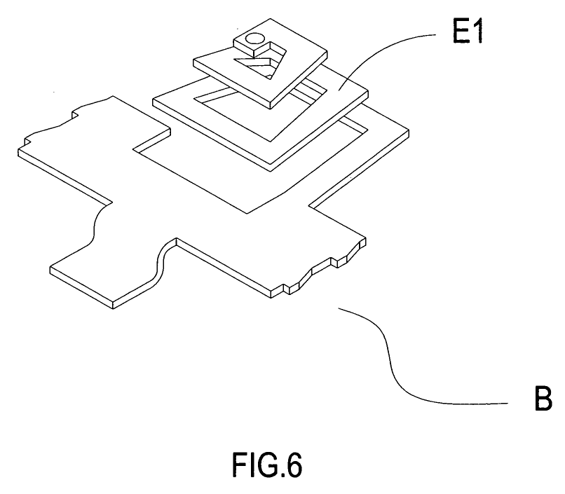

Referring to FIG. 4, FIG. 5 and FIG. 6, the base F installed with the elastic terminals B can be disposed within a cell phone case G, and firm clasping of the elastic terminals B in the base F, the helical members E1 extending from the elastic portions E, the electrical conducting points E2 that enable conducting of electric power respectively extending from the helical members E1 and elastic compression of the helical members E1 are used to enable a corresponding conducting member G1 of the cell phone case G to compress the electrical conducting points E2 to achieve effectiveness of efficient conducting of electric power. Furthermore, the helical member E1 can be configured as a ring-like helical member, a rectangular helical member, an elliptical helical member and related helical members that can be formed by machine extruding.

In order to better explicitly disclose advancement and practicability of the present invention, a comparison with prior art is described hereinafter:

Shortcomings of prior art

1. Additional molding must be implemented separately.

2. Processing steps are finicky and troublesome.

3. Elastic fatigue and the problem of poor conduction easily occur.

4. Cost of the manufacturing process is high.

Advantages of the present invention

1. Eliminates the need to implement separate molding.

2. Reduces the processing steps.

3. Minimizing the problem of elastic fatigue.

4. Saves on cost.

5. Provided with advancement and practicability.

6. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An elastic terminal structure, wherein an elastic terminal comprises an extended portion, from which extend mutually corresponding embedding members, a soldering portion extending from a side of the extended portion and a soldering piece that enables electrical conduction extending from the soldering portion; wherein:
an elastic portion extends from another side of the extended portion, and a helical member extends from the elastic portion; an electrical conducting point that enables conducting of electric power extends from the helical member, and elastic compression of the helical member is used to enable a conducting member to compress the electrical conducting point, moreover, the cost of the manufacturing process is reduced and the problem of elastic fatigue is minimized.

2. The elastic terminal structure according to claim 1, wherein the elastic terminals are installed in a base that is provided with functionality to enable electrical conductivity and embedding of the elastic terminals, and the embedding members of the elastic terminals function in coordination with clasp slots of the base to enable joining therein and achieve normal conducting effectiveness.

3. The elastic terminal structure according to claim 1, wherein the elastic portion extending from the extended portion is machine extruded from a plane surface of the extended portion to form the helical member having elastic compression to effectively reduce machine processing time and save on molding costs.

4. The elastic terminal structure according to claim 1, wherein the helical member is configured as a ring-like helical member, a rectangular helical member, an elliptical helical member and related helical members that can be formed by machine extruding.
